(19) United States
(12) Patent Application Publication
(10) Pub. No.: US 2025/0264852 A1
(43) Pub. Date: Aug. 21, 2025

(54) PROGRAMMABLE LOGIC CONTROLLER

(71) Applicant: Keyence Corporation, Osaka (JP)

(72) Inventor: Tomonobu KITAGAWA, Osaka (JP)

(73) Assignee: Keyence Corporation, Osaka (JP)

(21) Appl. No.: 19/023,510

(22) Filed: Jan. 16, 2025

(30) Foreign Application Priority Data
Feb. 21, 2024 (JP) 2024-024317

(51) Int. Cl. G05B 19/05

(52) U.S. Cl. CPC G05B 19/05; G05B 2219/14131

(57) ABSTRACT

To facilitate management of execution of a user program such as a ladder program and motion control. A processor includes a first core that executes a control logic operation based on a user program and a second core that executes motion control based on the user program. A memory stores a first variable group accessed when the control logic operation is executed by the first core and a second variable group accessed when the motion control is executed by the second core. A management unit performs management such that the control logic operation executed by the first core and refresh processing of the first variable group stored in the memory are sequentially executed. A synchronization control unit synchronizes a variable related to the motion control in the first variable group with a corresponding variable in the second variable group through the refresh processing.

### CROSS-REFERENCE TO RELATED APPLICATIONS

The present application claims foreign priority based on Japanese Patent Application No. 2024-024317, filed Feb. 21, 2024, the contents of which are incorporated herein by reference.

### BACKGROUND OF THE INVENTION

### 1. TECHNICAL FIELD

The invention relates to a programmable logic controller.

### 2. DESCRIPTION OF THE RELATED ART

In factory automation, a programmable logic controller (PLC) is a core controller that controls industrial machines. A technology for controlling a position of a workpiece or the like by driving a motor by a motor driving apparatus (motion unit) connected to a PLC is called motion control (JP 2006-107312 A and JP 2006-178818 A).

When a ladder program is executed by the PLC, a motion instruction value according to the ladder program is generated, and the motion instruction value is transmitted to the motor or the like at a predetermined timing.

Meanwhile, a case in which a multi-core processor is used also in the PLC has appeared as processor technology advances. As the ladder program and a motion are processed by cores in a distributed manner using the multi-core processor, there is an advantage that performance improves and mutual processing hardly interferes. On the other hand, an interchange between data read and written by execution of the ladder program and data read and written by the motion control becomes complicated.

### SUMMARY OF THE INVENTION

Therefore, an object of the invention is to facilitate management of execution of a user program such as a ladder program and motion control.

For example, the invention provides
a programmable logic controller including:
a processor including a first core that executes a control logic operation based on a user program and a second core that executes motion control based on the user program;
a memory that stores a first variable group accessed when the control logic operation is executed by the first core and a second variable group accessed when the motion control is executed by the second core;
a management unit that performs management such that the control logic operation executed by the first core and refresh processing of the first variable group stored in the memory are sequentially executed; and
a synchronization control unit that synchronizes a variable related to the motion control in the first variable group with a corresponding variable in the second variable group through the refresh processing.

According to the invention, it is easy to manage the execution of the user program such as the ladder program and the motion control.

### BRIEF DESCRIPTION OF THE DRAWINGS

FIG. 1 is a diagram illustrating a PLC system;

FIG. 2 is a diagram illustrating a basic unit;

FIG. 3 is a view illustrating processing executed by a first core;

FIG. 4 is a view illustrating processing executed by a second core;

FIG. 5 is a view illustrating synchronization processing of an input variable group;

FIG. 6 is a view illustrating a user interface for selecting a synchronization technique;

FIG. 7 is a view illustrating a function block;

FIG. 8 is a view illustrating a variable group;

FIG. 9 is a view illustrating a method of synchronizing operation instructions;

FIG. 10 is a view illustrating a method of synchronizing output variables; and

FIG. 11 is a view illustrating synchronization processing executed at an execution timing of a function block.

### DETAILED DESCRIPTION

Hereinafter, an embodiment will be described in detail with reference to the accompanying drawings. Note that the following embodiment does not limit the invention according to the claims, and all combinations of characteristics described in the embodiment are not necessarily essential for the invention. Two or more characteristics of a plurality of characteristics described in the embodiment may be arbitrarily combined. Further, the same or similar configurations are denoted by the same reference numerals, and redundant description will be omitted.

### (1) PLC System

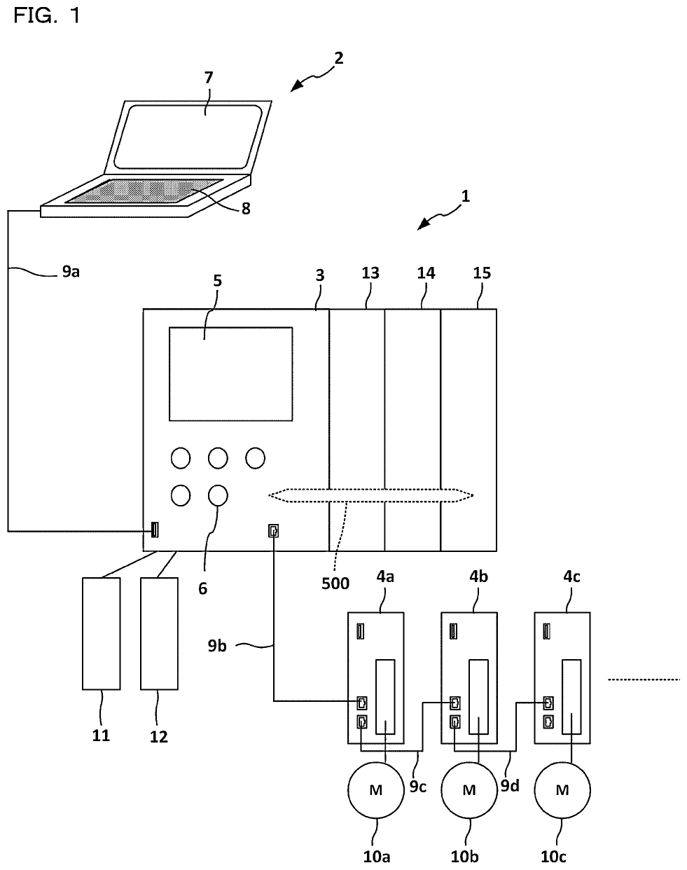

FIG. 1 illustrates a configuration example of a programmable logic controller system (hereinafter, referred to as a PLC system 1) according to the embodiment of the invention. As illustrated in FIG. 1, the PLC system 1 includes: a PC that is a setting support apparatus configured to edit a user program such as a ladder program; a basic unit 3 that is a programmable logic controller (PLC) configured for integrated control of various control apparatuses installed in a factory or the like; expansion units 13 to 15 connected via an expansion bus 500; and a plurality of motor drivers 4a to 4c. Examples of the plurality of expansion units 13 to 15 include various units such as a motion unit, an input unit, an output unit, an input/output unit (I/O unit), an analog conversion unit, and a communication unit. The plurality of motor drivers 4a to 4c drive motors 10a, 10b, and 10c, respectively.

The user program created by the PC 2, which is the setting support apparatus, may be created using a graphical programming language such as a ladder language or a flowchart-format motion program, or may be created using a high-level programming language such as C language.

In the PLC system 1, one or the plurality of expansion units 13 to 15 (for example, an I/O unit, an analog input unit, and an analog output unit) are connected to the basic unit 3. The basic unit 3 is sometimes also referred to as a CPU unit or a main unit. The motor drivers 4a to 4c may be referred to as slave equipment or peripherals.

The basic unit 3 includes a display unit 5 and an operation unit 6. The display unit 5 can display operation statuses of the motor drivers 4a to 4c. The display unit 5 may switch display content according to operation content of the operation unit 6. The display unit 5 normally displays a current value (device value) of a device in the PLC system 1, information on an error (presence or absence of an alarm or warning) occurring in the PLC system 1, and the like. The device is a name indicating an area on a memory provided to store a device value (device data), and may be referred to as a device memory. The device value is information indicating an input state from input equipment, an output state to output equipment, or a state of an internal relay (auxiliary relay), a timer, a counter, a data memory, or the like set on the user program. Types of the device value include a bit type and a word type. A bit device stores a 1-bit device value. A word device stores a device value of one word.

The motor drivers 4a to 4c are prepared to extend functions of the PLC system 1. The motors 10a to 10c are controlled by the motor drivers 4a to 4c, respectively. The motor drivers 4a to 4c supply electric power to the motors 10a to 10c, and control a rotation amount and the like according to a command from the basic unit 3. Examples of the motors 10a to 10c include a servo motor and a stepping motor.

The PC 2 is a computer that provides a development environment of the PLC system 1. The PC 2 is, for example, a portable notebook type or tablet type personal computer, and includes a display unit 7 and an operation unit 8. The ladder program, which is an example of the user program configured to control the PLC system 1, is created using the PC 2. The created ladder program is converted into a mnemonic code in the PC 2. The PC 2 is connected to the basic unit 3 of the PLC system 1 via a communication cable 9a such as a universal serial bus (USB), and sends the ladder program converted into the mnemonic code to the basic unit 3. The basic unit 3 converts the ladder program into a machine code and stores the machine code in a memory provided in the basic unit 3. Note that the mnemonic code is transmitted to the basic unit 3 here, the invention is not limited thereto. For example, the PC 2 may convert the mnemonic code into an intermediate code, and send the intermediate code to the basic unit 3.

Note that the operation unit 8 of the PC 2 may include a pointing device such as a mouse connected to the PC 2 although not illustrated in FIG. 1. Further, the PC 2 may be configured to be detachably connected to the basic unit 3 via another communication cable 9a other than the USB. Further, the PC 2 may be wirelessly connected to the basic unit 3 without using the communication cable 9a. In this case, the communication cable 9a may be understood to represent a wireless link.

The basic unit 3 and the motor driver 4a are connected by a communication cable 9b, and can perform communication (for example, cyclic communication and message communication) with each other via the communication cable 9b. The motor driver 4a and the motor driver 4b are connected by a communication cable 9c, and can communicate with each other via the communication cable 9c. The motor driver 4b can communicate with the basic unit 3 via the communication cables 9b and 9c. The motor driver 4b and the motor driver 4c are connected by a communication cable 9d, and can communicate with each other via the communication cable 9d. Further, the motor driver 4c can communicate with the basic unit 3 via the communication cables 9b, 9c, and 9d.

Hereinafter, the motor drivers 4a to 4c are expressed as motor drivers 4 when common matters are described. Similarly, the motors 10a to 10c are expressed as motors 10 when common matters are described.

The basic unit 3 may receive a detection signal from a sensor 11 connected to the basic unit 3, and may control a load 12 (for example, an air cylinder or a hydraulic cylinder) and the like connected to the basic unit 3. Note that the motor drivers 4 and the motors 10 may also be an air cylinder, a hydraulic cylinder, and the like.

### (2) Basic Unit

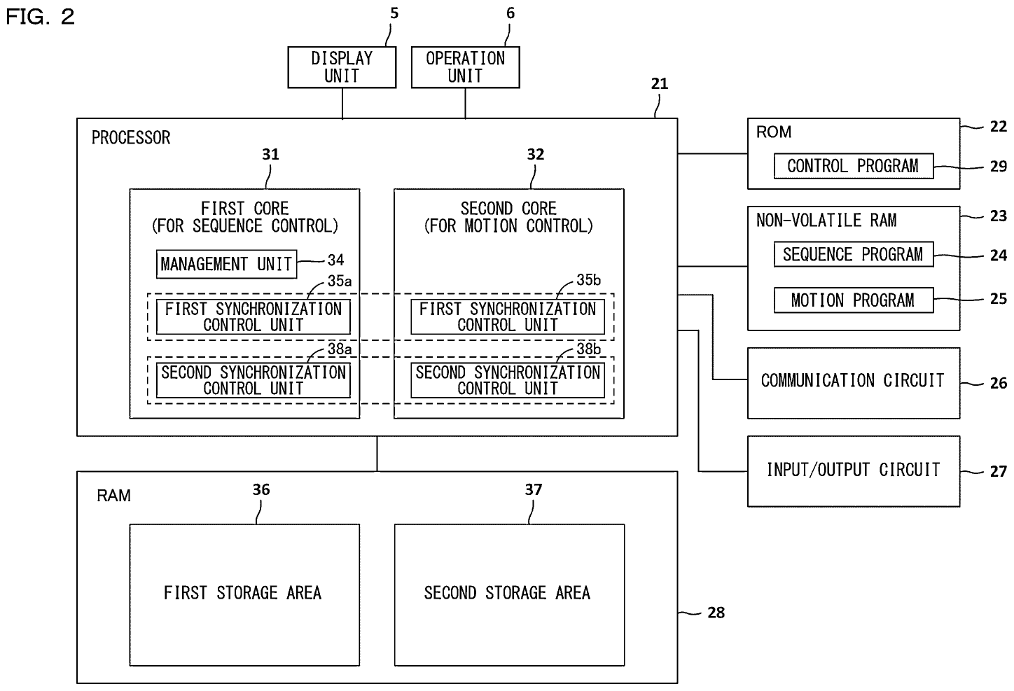

FIG. 2 illustrates a hardware configuration of the basic unit 3. A processor 21 includes a plurality of CPU cores (for example, a first core 31 and a second core 32). The ROM 22 is a non-volatile memory and stores a control program 29. A non-volatile RAM 23 stores user programs (a sequence program 24 and a motion program 25) created by the PC 2. A communication circuit 26 includes various communication circuits (for example, a serial communication circuit, a parallel communication circuit, a wired network communication circuit, and a wireless communication network circuit) configured to communicate with the PC 2, the motor driver 4, and the like. An input/output circuit 27 includes an input circuit that receives an input of a signal from an input apparatus (the sensor 11) and an output circuit that outputs a control signal to the load 12.

The first core 31 is a CPU core that executes sequence control according to the sequence program 24. The sequence program 24 is, for example, a ladder program described in a ladder language or a program described in an ST language. ST is an abbreviation of structured text. The sequence control includes interlocking, process progress, and the like. Interlocking refers to prohibiting a certain process when a certain condition is satisfied (or not satisfied). Examples thereof include prohibiting a robot arm from operating when a door of a safety fence is open. The process progress means executing a plurality of processes according to a predetermined order. The second core 32 is a CPU core that executes motion control according to the motion program 25. A control target of the motion control is, for example, a linear motion stage or a robot (for example, the motor 10). Further, the motion control is driven by the sequence control. The motion control receives an operation instruction as the sequence control as one process of the sequence control, executes an operation according to the operation instruction, and outputs a completion signal to the sequence control. The motion control discloses a position (distance), a speed, a torque, and the like, and a state (status) of a signal involved in the motion control to the sequence control. The sequence control uses these to determine the next operation instruction. The motion control executes a predetermined operation using, for example, a movement distance, a speed, an acceleration, a jerk, or the like. When interpolation of position data is executed, information indicating a trajectory is required. When torque control is executed, a torque instruction value is required. These may be transferred in advance as parameters, or may be handed over from the sequence control to the motion control simultaneously with the operation instruction.

The basic unit 3 has a function of executing a sequence control program written in the ladder (LD) language or the ST language. Furthermore, the basic unit 3 of the present embodiment may also have a communication function and a motion control function. The communication function and the motion control function of the basic unit 3 are handled like an expansion unit built in the basic unit 3.

The basic unit 3 and each of the expansion units 13 to 15 of the PLC each execute iterative processing. A timing at which the basic unit 3 executes the program can be matched with a timing at which the expansion units 13 to 15 execute iterative processing, or data exchange can be executed in synchronization. Such a function may be referred to as a so-called “inter-unit synchronization function”. The motion control function and the sequence control function included in the basic unit 3 can also be matched in processing execution timing by the “inter-unit synchronization function”, and data exchange can be executed in synchronization.

Both the sequence control and the motion control are repeatedly executed (loop). A cycle of the sequence control is called a scan, a scan cycle, a scan time, or the like, and has a variable length. The first core 31 executes the sequence program 24 in each scan and updates a state of the interlocking or the process progress. There are various types of control content of the sequence program 24 including communication with the outside, product data collection, temperature control, and the like in addition to the motion control. Therefore, the sequence program 24 is likely to have a large scale and a long scan cycle (scan time). The scan time is several 10 μs to several 10 ms according to the scale and content of the PLC system 1. The scan time is variable in each scan, and may change according to a state (immediately after activation, during manufacturing of a product, when an error occurs in production, or the like) of the PLC system 1.

An execution cycle of the motion control is referred to as a “control cycle”. The second core 32 executes the motion program 25 in each control cycle, monitors an activation signal from the outside (for example, sequence control), updates an instruction with respect to the motor driver 4, and updates a state disclosed to the sequence control. The instructions with respect to the motor driver 4 are desirably issued at regular intervals in order to secure the stability of a feedback instruction. Thus, the control cycle is generally a constant cycle. A wire saving system (servo wire saving system) may be used as a communication system between the basic unit 3 and the motor driver 4. In this case, in the servo wire saving system, the basic unit 3 serves as a master, and the motor driver 4 serves as a slave. Then, the master and the slave cooperate to transmit instructions at regular intervals. For this reason as well, the control cycle is a constant cycle.

A RAM 28 has a first storage area 36 in which a variable group for the sequence control is stored and a second storage area 37 in which a variable group for the motion control is stored. The first storage area 36 stores, for example, a first variable group A used by the sequence control. The second storage area stores a second variable group B used by the motion control. That is, the first storage area 36 stores an input variable and an output variable read and written by the sequence control. The second storage area 37 stores variables read and written by the motion control.

Note that variables A1, A2, A3, and so on included in the first variable group A and the variables B1, B2, B3, and so on included in the second variable group B are correlated (associated or linked). For example, the variable B1 corresponding to the variable Al included in the first variable group A is included in the second variable group B. Thus, the variable A1 and the variable B1 are correlated and need to be synchronized. Conversely, the variable A2 corresponding to the variable B2 included in the second variable group is included in the first variable group A. Thus, the variable A2 and the variable B2 are correlated and need to be synchronized.

The first core 31 updates the variables stored in the first storage area 36 in each scan time according to the sequence control. The second core 32 updates the variables stored in the second storage area 37 in each control cycle according to the motion control.

The first core 31 also functions as a management unit 34, a first synchronization control unit 35a, and a second synchronization control unit 38a. The second core 32 also functions as a first synchronization control unit 35b and a second synchronization control unit 38b. The management unit 34 performs management such that a control logic operation executed by the first core 31 and refresh processing of the first variable group stored in the first storage area of the RAM 28 are sequentially executed.

The first synchronization control unit 35a and the first synchronization control unit 35b operate in cooperation with each other to synchronize input variables. For example, the first synchronization control unit 35a and the first synchronization control unit 35b synchronously copy the input variables stored in the second storage area 37 to the first storage area 36. The first synchronization control unit 35a and the first synchronization control unit 35b may communicate with each other to notify a timing of copying the variables. Alternatively, the first synchronization control unit 35a and the first synchronization control unit 35b may communicate with each other via the management unit 34 to notify the timing of copying the variables. Alternatively, the first synchronization control unit 35a and the first synchronization control unit 35b may copy the variables based on the timing notified from the management unit 34.

The second synchronization control unit 38a and the second synchronization control unit 38b operate in cooperation with each other to synchronize output variables. The second synchronization control unit 38a and the second synchronization control unit 38b synchronously copy the output variables stored in the first storage area 36 to the second storage area 37. The second synchronization control unit 38a and the second synchronization control unit 38b may communicate with each other to notify the timing of copying the variables. Alternatively, the second synchronization control unit 38a and the second synchronization control unit 38b may communicate with each other via the management unit 34 to notify the timing of copying the variables. Alternatively, the second synchronization control unit 38a and the second synchronization control unit 38b may copy the variables based on the timing notified from the management unit 34.

Such synchronous copy processing is called refresh. By the synchronous copy processing, the input variables stored in the first storage area 36 are updated in synchronization with execution of the sequence control. The output variables stored in the first storage area 36 are output in synchronization with execution of the sequence control.

The sequence control may include a plurality of tasks. When the sequence control includes the plurality of tasks, a user can select any task with which the storage area is to be copied. For example, copying may be executed at the end of a task with the lowest priority, or copying may be executed at the end of inter-unit synchronization executed as an interrupt synchronized with the motion control. These can be selected by the user.

The second synchronization control unit 38a and the second synchronization control unit 38b synchronize a variable (for example, an operation instruction, an instruction value, or a status) related to the motion control in the first variable group with a corresponding variable in the second variable group through the refresh processing. For example, a variable storing an operation instruction issued by the sequence control is copied to a variable on the motion control side. Further, a variable storing a current value (movement distance) or a status in the motion control is copied to a variable on the sequence control side.

More specifically, the first synchronization control unit 35a and the first synchronization control unit 35b copy an input variable in the variable group stored in the second storage area 37 to a corresponding input variable in the variable group stored in the first storage area 36. The second synchronization control unit 38b and the second synchronization control unit 38b copy an output variable in the variable group stored in the first storage area 36 to a corresponding output variable in the variable group stored in the second storage area 37. As synchronization processing, there are refresh executed before the start or after execution (END processing) of the sequence control with the lowest priority and refresh executed at a timing of inter-unit synchronization processing executed as an interrupt during the sequence control. Which synchronization processing is to be applied is designated by setting information set in advance by the PC 2. Different settings may be adopted for each variable and for each node.

The first synchronization control units 35a and 35b control spinlock or semaphore for the first storage area 36. The second synchronization control units 38a and 38b control spinlock or semaphore for the second storage area 37.

The processor 21 is connected to the PC 2 via the communication circuit 26, and is connected to the motor driver 4 via the communication circuit 26 to perform communication. The communication circuit 26 may include, for example, a serial communication circuit compatible with a USB. The communication circuit 26 may include a communication circuit capable of executing communication compatible with a protocol of Industrial Ethernet (for example, EtherCAT, EtherNet/IP, PROFINET, and MECHATROLINK-III). The communication circuit 26 may execute cyclic communication and message communication.

### (3) Multi-Core Processor

In the present embodiment, the processor 21 is a multi-core processor. Here, the reason why the core that executes the sequence control and the core that executes the motion control are separated will be described.

As described above, the motion control needs to update an instruction with respect to the motor driver 4 in each control cycle. Therefore, the control cycle is required to be maintained constant. On the other hand, the dependency of the control cycle of the motion control on control content is relatively low. Thus, the control cycle of the motion control is easily maintained constant.

There are various types of control content of the sequence control. For example, the sequence control may include a loop with a heavy load, processing in which processing time depends on an external environment, and the like. Further, the processing time may greatly change depending on a description method of the sequence program 24 and an external environment, and the scan time may greatly change. However, the change in the scan time is allowed in the sequence control in more cases as compared with the motion control.

In the related art, the sequence control and the motion control are executed in a single core. As described above, the repetition cycle (scan time) of the sequence control is a variable cycle, but the execution cycle (control cycle) of the motion control is a constant cycle. Although a task of the sequence control and a task of the motion control are executed in a time division manner, if the task of the sequence control takes time, this affects the motion control. That is, there is a possibility that the execution cycle (control cycle) of the motion control is not constant to cause a control error. For example, it is assumed that an operation instruction for a first axis and an operation instruction for a second axis are issued at the i-th scan time. Note that, on the sequence control side, it is assumed that the operation instruction for the first axis and the operation instruction for the second axis are simultaneously executed in parallel. In this case, on the motion control side, there may be a case where the operation instruction for the first axis is executed in the j-th control cycle and the operation instruction for the second axis is executed in the (j+1)-th control cycle. As described above, on the sequence control side, it is assumed that the operation instruction for the first axis and the operation instruction for the second axis are simultaneously executed in parallel in the same control cycle. Thus, if the operation instruction for the first axis is executed in the j-th control cycle and the operation instruction for the second axis is executed in the (j+1)-th control cycle, there may be a problem that the timing of executing the control is shifted depending on the axis, a control error occurs, or the like.

In a case where the processor 21 is the multi-core processor, it is advantageous that the sequence control and the motion control are assigned to different cores, respectively. That is, the motion control and the sequence control are executed independently and hardly interfere with each other.

However, when the different cores are allocated to the sequence control and the motion control, the following problems occur. It is necessary to quickly transmit an instruction output from the sequence control to the motion control. The motion control needs to quickly transmit completion of a predetermined operation to the sequence control. Therefore, it is desirable to reduce an information transmission delay (delay reduction).

The sequence control may execute certain processing by combining a plurality of pieces of data. In such a case, it is desirable that consistency between the plurality of pieces of data is always maintained. The same data is repeatedly updated during one scan, and the data is settled at the end of the scan. In this case, it is desirable that the data is not referred to in the middle of the scan. Therefore, it is desirable that “a set of pieces of data is collectively read and written” (securement of simultaneity between a plurality of pieces of data).

Note that the sequence control may be divided into first sequence control involved in the motion control and second sequence control not involved in the motion control. Then, the first core 31 executes the second sequence control, and the second core 32 executes the first sequence control and the motion control. In this case, since a scan time of the first sequence control coincides with the control cycle of the motion control, the delay reduction and the securement of simultaneity would be realized. However, the user needs to appropriately adjust a size of a program for the first sequence control such that the scan time of the first sequence control coincides with the control cycle of the motion control, which is extremely difficult work for the user. Further, it is necessary to reduce the delay and secure the simultaneity between the first sequence control and the second sequence control.

### (3) Solution

(3-1) Synchronization of Input Variables

In the present embodiment, the first storage area 36, which is a storage area for the sequence control, and the second storage area 37, which is a storage area for the motion control, are secured independently and separately in the RAM 28. The first storage area 36 stores the variable group A referred to by the sequence control. The second storage area 37 stores the variable group B updated by the motion control. The first core 31 sequentially executes the sequence control and the refresh of the variable group A. Here, the first synchronization control units 35a and 35b copy the variable group B updated by the motion control to the variable group A referred to by the sequence control as the refresh.

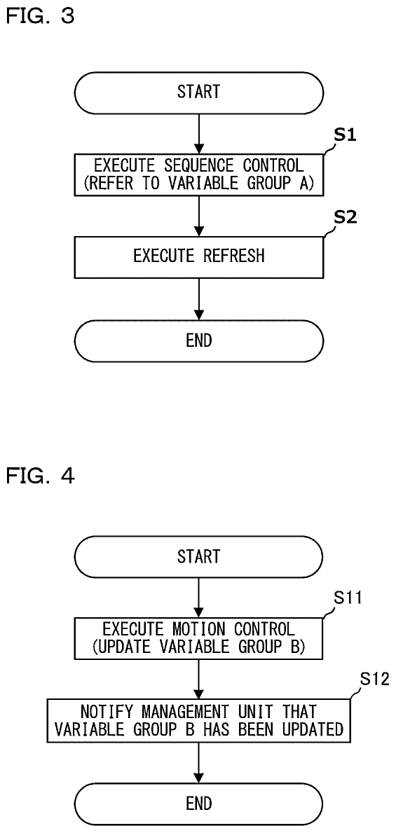

FIG. 3 illustrates processing in each scan executed by the first core 31.

In S1, the first core 31 executes the sequence control according to the sequence program 24. The first core 31 refers to the variable group A stored in the first storage area 36 in each scan.

In S2, the first core 31 executes the refresh. As described above, the first core 31 (the first synchronization control units 35a and 35b) copies the variable group B updated by the motion control to the variable group A referred to by the sequence control.

FIG. 4 illustrates processing in each control cycle executed by the second core 32.

In S11, the second core 32 executes the motion control according to the motion program 25. Here, the second core 32 can update the variable group B in each control cycle. For example, the second core 32 may rewrite the variable group B many times within one control cycle.

In S12, the second core 32 notifies the management unit 34 that the variable group B has been updated. When being notified that the variable group B has been updated, the management unit 34 instructs the first synchronization control units 35a and 35b to copy (synchronize) the variable group B to the variable group A at the next refresh timing.

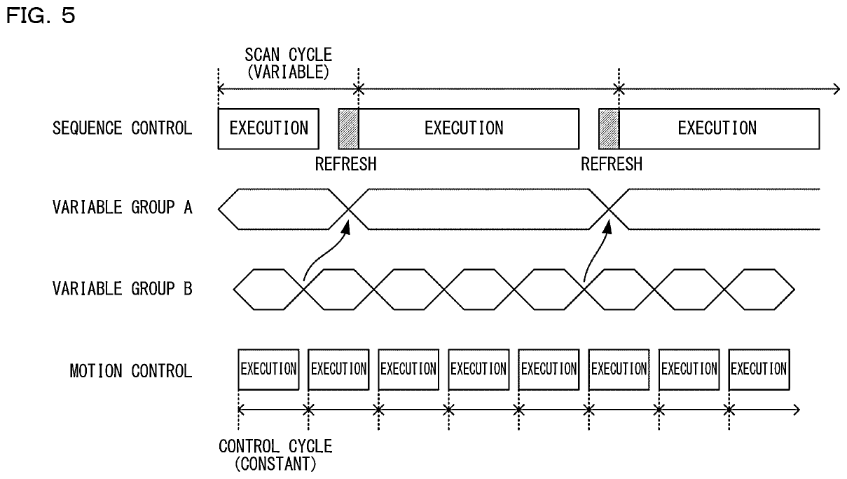

FIG. 5 illustrates a timing at which the variable group B is reflected on the variable group A by the refresh. As described above, the execution cycle (scan time) of the sequence control is variable, but the execution cycle (control cycle) of the motion control is constant. When the first sequence control ends, the first synchronization control units 35a and 35b execute the refresh. That is, at that time, the variable group B stored in the second storage area 37 is copied to the corresponding variable group A. Note that a timing at which values of a plurality of variables included in the variable group B are changed by the motion control varies, but the values of the plurality of variables included in the variable group B are simultaneously settled at the end of the control cycle. Further, since the variable group B is simultaneously copied to the variable group A, the simultaneity between the plurality of variables is secured.

### (3-2) Setting of Execution Timing of Refresh

The sequence control includes a plurality of tasks. Each of the tasks includes a plurality of types of processing executed sequentially (in series). The plurality of tasks are executed in parallel. However, the plurality of tasks of the sequence control are executed by the first core 31. Therefore, in practice, each of the tasks is executed in a time division manner according to the priority thereof. That is, a task having a higher priority is always executed in preference to a task having a lower priority.

Simple sequence control includes a single task. If processing content of the sequence control is small, the scan time is shortened. If processing content of the sequence control is large, the scan time is long or varies.

Complex sequence control includes a plurality of tasks. Processing that needs to be executed in a short cycle is described in a task having a short execution cycle.

Two or more priorities are provided. For example, there may be four priority levels.
(i) Priority: High, Highest priority. Interrupt.
(ii) Priority: Medium, Interrupt that is executed when interrupt with priority “high” has not been executed.
(iii) Priority: Low, Processing that is executed when interrupt with priority “high” and interrupt with priority “medium” have not been executed.
(iv) Scan, Processing that is executed when interrupts with all priorities have not been executed.

The priority is set in the PC 2 for each task (program module), and is written in the non-volatile RAM 23 as setting information constituting a part of a project. Among the plurality of tasks included in the sequence control, a task involved in the motion control may be set to have a higher priority than a priority of a task not involved in the motion control. As a result, responsiveness to the sequence control of the variable group involved in the motion control is improved, and the simultaneity between the plurality of variables included in the variable group is maintained.

Specifically, the refresh of the variable group involved in the motion control is executed in linkage with any one task. In sequence control of the linked task, it is possible to refer to the variable group B of the motion control with a delay time of one cycle while maintaining the simultaneity.

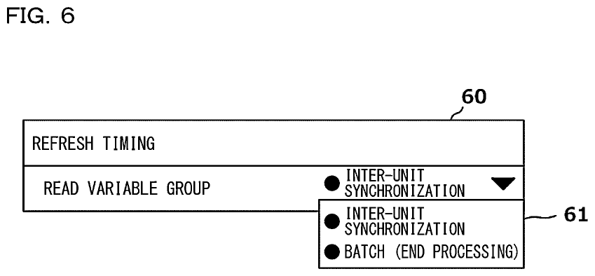

FIG. 6 illustrates a UI 60 for setting a refresh timing displayed on the display unit 7 by the PC 2. The UI is an abbreviation for user interface. In this example, the UI 60 includes a pull-down list 61 that displays a plurality of refresh timings (refresh techniques) as options. The user selects any one of the options from the pull-down list 61 through the operation unit 8.

When “inter-unit synchronization” is selected, variable group synchronization processing is executed at an execution timing of the inter-unit synchronization. The inter-unit synchronization is one of tasks. Any priority may be assigned to the inter-unit synchronization.

The inter-unit synchronization function synchronizes an execution timing of a task (sequence program) of the basic unit 3 and an execution timing of iterative processing of the expansion units 13 to 15 as described above. When the refresh timing of variables is set to the inter-unit synchronization, the execution of the task of the basic unit 3, the iterative processing of the expansion units 13 to 15, and synchronization processing of the input and output variables of the motion control of the basic unit 3 can all be executed in synchronization. Furthermore, when the motion control function built in the basic unit 3 is set as a target of the inter-unit synchronization, iterative processing of the built-in motion control function can also be set as a target of the synchronization.

When “batch (END processing)” is selected, the variable group synchronization processing is executed at an execution timing of the refresh. The execution of the sequence program 24 and the END processing (data exchange with various peripheral functions) are sequentially executed within one scan time. The refresh related to the motion control is also executed at a timing of the END processing.

Further, here, only “inter-unit synchronization” and “batch (END processing)” are shown as the timing options. However, program execution by interrupts from the expansion units 13 to 15 or program execution in a fixed cycle in the basic unit 3 may be selectable as the timing.

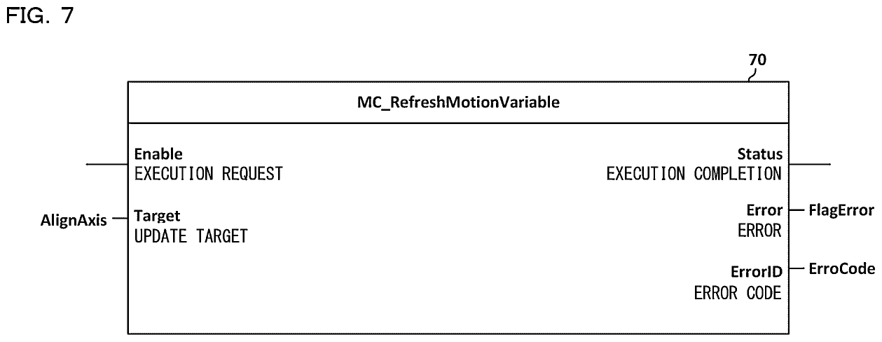

The basic unit 3 has a direct communication function. FIG. 7 illustrates a function block 70 configured to execute direct communication. The function block 70 is described in the sequence program 24. There is a case where it is necessary to obtain the latest variable values just when being required by the sequence program 24. In such a case, when the function block 70 is executed, a status is updated at the moment. In this example, variables to be updated are designated as an update target Target by the direct communication. As described above, by using the function block 70, some variables can be synchronized without waiting for the refresh.

### (3-3) Mechanism of Variables for Implementing Refresh

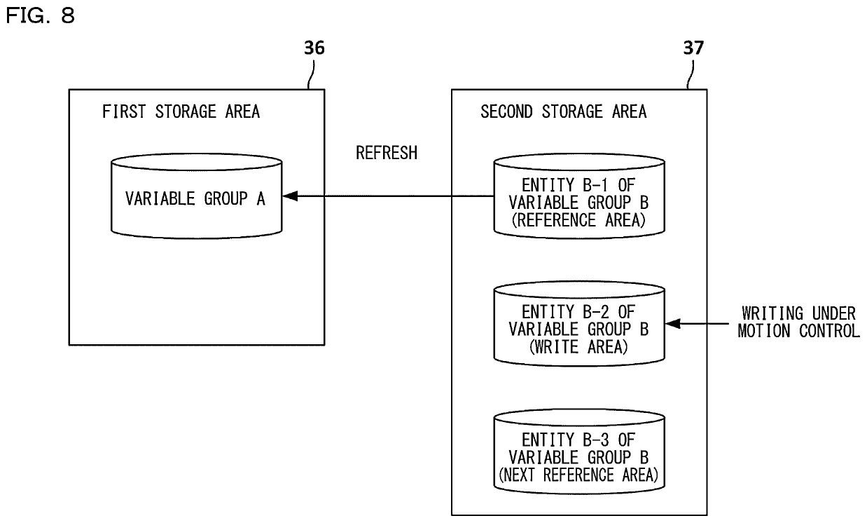

FIG. 8 illustrates a mechanism of variables for implementing the refresh. The refresh and the sequence control are sequentially executed. In the refresh, the first synchronization control units 35a and 35b cooperatively copy the variable group B (input variables) for the motion control stored in the second storage area 37 to the variable group A (input variables) for the sequence control stored in the first storage area 36. The motion control is also being executed during copying. The refresh needs to be devised in order to secure the simultaneity between the plurality of variables included in the variable group B.

According to FIG. 8, the variable group B for the motion control has three entities B-1, B-2, and B-3. In the initial state, the entity B-1 is an entity referred to as a copy source by the sequence control. The entity B-2 is an entity serving as a write target by the motion control. The entity B-3 is an entity to be used for the next reference. That is, the entity B-3 is the next write target by the motion control, and is the next reference area by the sequence control. Which area (role) is assigned to each of the entities B-1, B-2, and B-3 may be stored in the RAM 28.

The motion control (the first synchronization control units 35a and 35b) exchanges the entity B-2 as the write target with the entity B-3 as the next reference area before the variable group B is updated. That is, the entity B-2 is changed to the next reference area, and the entity B-3 is changed to a write target area.

Before the sequence control reads values of the variable group B from the entity B-1, the first synchronization control units 35a and 35b determine whether the entity B-2 changed from the write target area to the next reference area has been updated. When the entity B-2 has been updated, the first synchronization control units 35a and 35b exchanges the entity B-1 as a copy source area and the entity B-2 as the next reference area. That is, the role of the entity B-2 is changed to the copy source area, and the role of the entity B-1 is changed to the next reference area. As a result, the latest values are read from the entity B-2 holding the latest values written by the motion control, and are copied to the variable group A.

Meanwhile, each of the sequence control and the motion control needs to make a variable area exclusive (to be prevented from being operated by the other side during its own writing). However, the second storage area 37 only required to be exclusive for a very short time required to switch the roles of the entities.

Since the three entities B-1, B-2, and B-3 are prepared for the variable group B in this manner, the motion control can always write the latest values in the variable group B. Furthermore, the sequence control may always refer to the “latest values” that have just been updated by the motion control.

Note that, similarly, entities A-1, A-2, and A-3 may be prepared for the variable group A, and roles of the entities A-1, A-2, and A-3 may be switched.

### (3-4) Update of Output Variables, etc.

### (3-4-1) Operation Instruction

The above description relates to input variables, but is also applied to output variables.

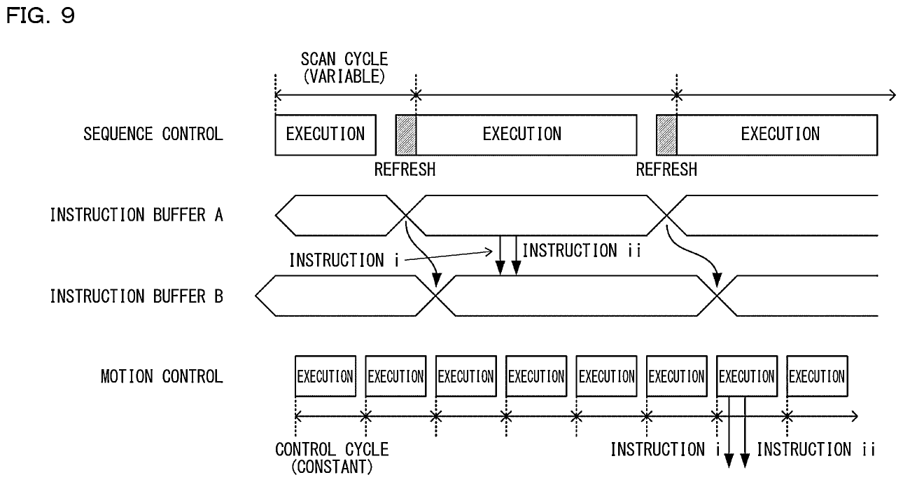

FIG. 9 is a view illustrating update processing related to output variables. Here, an instruction buffer A is secured in the first storage area 36, and an instruction buffer B is secured in the second storage area 37. In the instruction buffer A, an operation instructions, an output variable, and the like are written by the sequence control. Note that the operation instruction may also be understood as a part of an output variable. The instruction buffer B is updated by the second synchronization control units 38a and 38b at the end of the next control cycle after a timing at which the instruction buffer A is updated.

According to FIG. 9, at the second scan time, the first core 31 issues an operation instruction i and an operation instruction ii according to the sequence program 24, issues the operation instruction i and the operation instruction ii to the first storage area 36 functioning as the instruction buffer A, and stores the operation instruction i and the operation instruction ii in the first storage area 36 functioning as the instruction buffer A. Then, at a refresh timing at the end of the second scan time, the second synchronization control units 38a and 38b copy the operation instruction i and the operation instruction ii from the instruction buffer A to the instruction buffer B.

The second core 32 executes the operation instruction i and the operation instruction ii stored in the second storage area 37 functioning as the instruction buffer B according to the motion program 25 in a control cycle that arrives first after the refresh is executed. As a result, the operation instructions i and ii intended to be executed simultaneously in parallel on the sequence control side are also executed simultaneously in parallel on the motion control side.

### (3-4-2) Output Variables

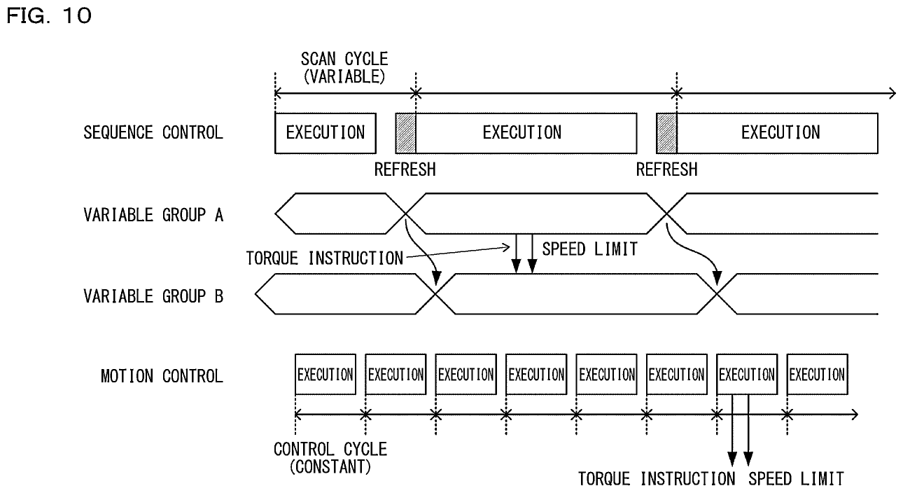

FIG. 10 illustrates how the variable group A (for example, a torque instruction and a speed limit) generated at a certain scan time by the first core 31 is transmitted to the second core 32. The first core 31 generates the variable group A (for example, the torque instruction and the speed limit) at the second scan time according to the sequence program 24 and stores the variable group A in the first storage area 36. The second synchronization control units 38a and 38b copy the variable group A (for example, the torque instruction and the speed limit) stored in the first storage area 36 to the variable group B of the second storage area 37 at the refresh timing at the end of the second scan time.

The second core 32 executes the motion program 25 using the variable group B (for example, the torque instruction and the speed limit) stored in the second storage area 37 in a control cycle that arrives first after the refresh is executed. As a result, the simultaneity is secured for the variable groups A and B (for example, the torque instruction and the speed limit).

### (3-5) Responsiveness-Priority

The responsiveness is sometimes to be prioritized over the simultaneity regarding operation instructions as compared with variable groups. For example, synchronization processing of the instruction buffers A and B may be executed at a timing when the function block 70 described above is executed.

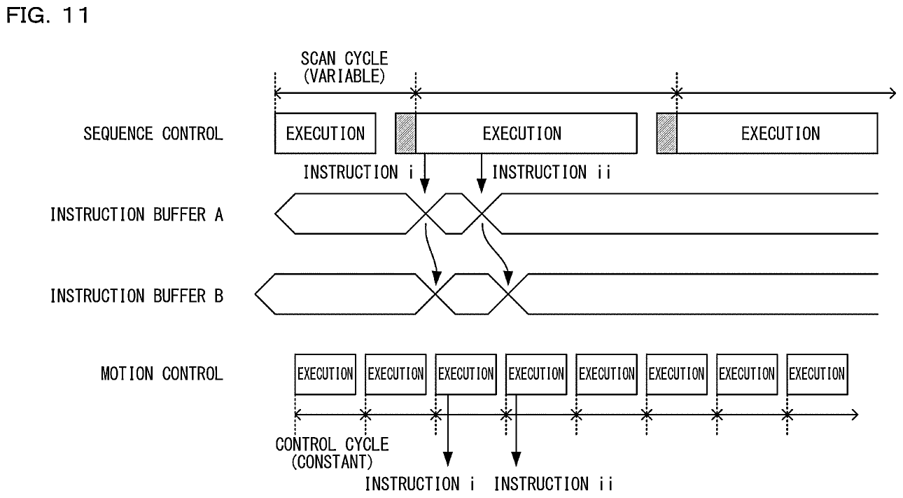

FIG. 11 illustrates a synchronization example of the instruction buffers A and B along execution timings of the function block 70. In this example, when the function block 70 is executed at the second scan time, the operation instruction i is issued and stored in the instruction buffer A of the first storage area 36. At the end of the next control cycle after this timing, the second synchronization control units 38a and 38b store the operation instruction i, stored in the instruction buffer A, in the instruction buffer B secured in the second storage area 37. The second core 32 executes the operation instruction i in the next control cycle.

Similarly, when the function block 70 is executed at the second scan time, the operation instruction ii is issued and stored in the instruction buffer A of the first storage area 36. At the end of the next control cycle after this timing, the second synchronization control units 38a and 38b store the operation instruction ii, stored in the instruction buffer A, in the instruction buffer B secured in the second storage area 37. The second core 32 executes the operation instruction ii in the next control cycle.

In this manner, the responsiveness may be prioritized over the simultaneity regarding the plurality of operation instructions.

### (3-6) Case Where Synchronization Timing of Input Variables and Synchronization Timing of Output Variables are Different

Regarding input variables, the simultaneity is generally prioritized over the responsiveness. Therefore, input variable update processing (synchronization processing) is executed at the end of the sequence control (refresh timing). On the other hand, regarding output variables, the responsiveness is prioritized over the simultaneity. Therefore, the output variables may be updated at the timing when the function block 70 is executed. In this manner, an update timing of the input variables may be different from an update timing of the output variables or operation instructions.

### (4) Technical Ideas Derived From Embodiment

### Viewpoint 1

A processor 21 includes a first core 31 that executes a control logic operation (for example, sequence control) based on a user program (for example, sequence program 24) and a second core 32 that executes motion control based on the user program. A RAM 28 stores a first variable group accessed when the control logic operation is executed by the first core 31 and a second variable group accessed when the motion control is executed by the second core 32. A management unit 34 performs management such that the control logic operation executed by the first core 31 and refresh processing of the first variable group stored in the RAM 28 are sequentially executed. First synchronization control units 35a and 35b and second synchronization control units 38a and 38b synchronize variables related to the motion control (for example, operation instructions i and ii or a torque instruction and a speed limit) in the first variable group with corresponding variables in the second variable group through the refresh processing. According to the embodiment, it is easy to manage execution of the user program (sequence program 24) such as a ladder program and the motion control.

### Viewpoint 2

The first synchronization control units 35a and 35b and the second synchronization control units 38a and 38b may synchronize the variables related to the motion control in the first variable group with the corresponding variables in the second variable group at a refresh processing timing designated in advance.

### Viewpoint 3

A user may designate an END processing timing in advance as the refresh processing timing. In this case, the first synchronization control units 35a and 35b and the second synchronization control units 38a and 38b may synchronize the variables related to the motion control in the first variable group with the corresponding variables in the second variable group at the END processing timing.

### Viewpoint 4

The user may designate an execution timing of inter-unit synchronization in advance as the refresh processing timing. In this case, the first synchronization control units 35a and 35b and the second synchronization control units 38a and 38b may synchronize the variables related to the motion control in the first variable group with the corresponding variables in the second variable group at the execution timing of the inter-unit synchronization.

### Viewpoint 5

The user may designate an execution timing of a predetermined task as the refresh processing timing in advance. Note that the predetermined task is also selected by the user in advance. In this case, the first synchronization control units 35a and 35b and the second synchronization control units 38a and 38b may synchronize the variables related to the motion control in the first variable group with the corresponding variables in the second variable group at the execution timing of the predetermined task.

### Viewpoint 6

There is a case where the variables related to the motion control in the first variable group are variables (input variables) input to the control logic operation. In this case, the first synchronization control units 35a and 35b may synchronize the variables related to the motion control in the first variable group with the corresponding variable in the second variable group through the refresh processing.

### Viewpoint 7

There is a case where the variables related to the motion control in the first variable group are variables (output variables or instructions) output from the control logic operation. In this case, the second synchronization control units 38a and 38b may synchronize the variables related to the motion control in the first variable group with the corresponding variables in the second variable group in response to execution of the control logic operation. As described above, synchronization processing (update processing) of the output variables may be executed at an execution timing of a function block 70 in sequence control.

### Viewpoint 8

The RAM 28 may have a first storage area 36 that is used by the control logic operation executed by the first core 31 and stores the first variable group, and a second storage area 37 that is used by the motion control executed by the second core 32 and stores the second variable group.

### Viewpoint 9

The first variable group may be updated along a scan cycle of the user program, the scan cycle being variable. The second variable group may be updated along a control cycle of the motion control, the control cycle being constant.

### Viewpoint 10

There is a case where inter-unit synchronization processing is selected instead of the refresh processing as processing of synchronizing the variables related to the motion control in the first variable group with the corresponding variables in the second variable group. In this case, the first synchronization control units 35a and 35b and the second synchronization control units 38a and 38b may synchronize the variables related to the motion control in the first variable group with the corresponding variables in the second variable group through the inter-unit synchronization processing.

### Viewpoint 11

The user program may include a command word (for example, function block 70) for synchronizing predetermined variables related to the motion control in the first variable group with predetermined corresponding variables in the second variable group. In this case, the first synchronization control units 35a and 35b and the second synchronization control units 38a and 38b may immediately synchronize the predetermined variables related to the motion control in the first variable group with the predetermined corresponding variables in the second variable group according to the command word.

### Viewpoint 12

The first variable group may include a plurality of output variables for transmitting a plurality of operation instructions issued by executing the user program. The second variable group may include a plurality of variables corresponding to the plurality of output variables for transmitting the plurality of operation instructions. The second synchronization control units 38a and 38b update the plurality of output variables in the same scan cycle among a plurality of consecutive scan cycles that are repeated execution cycles of the user program. The second synchronization control units 38a and 38b update the plurality of variables corresponding to the plurality of output variables for transmitting the plurality of operation instructions in the second variable group at the same timing. The motion control executes the plurality of operation instructions with reference to the plurality of variables in the same control cycle among a plurality of consecutive control cycles that are execution cycles of the motion control. As a result, simultaneity may be secured for the plurality of operation instructions.

The invention is not limited to the above embodiment, and various modifications and changes can be made within a scope of a gist of the invention.

What is claimed is:

1. A programmable logic controller comprising:
a processor including a first core configured to execute a control logic operation based on a user program and a second core configured to execute motion control based on the user program;
a memory configured to store a first variable group accessed when the control logic operation is executed by the first core and a second variable group accessed when the motion control is executed by the second core;
a management unit configured to perform management in such a manner that the control logic operation executed by the first core and refresh processing of the first variable group stored in the memory are sequentially executed; and
a synchronization control unit configured to synchronize a variable related to the motion control in the first variable group with a corresponding variable in the second variable group.

2. The programmable logic controller according to claim 1, wherein the synchronization control unit synchronizes the variable related to the motion control in the first variable group with the corresponding variable in the second variable group at a refresh processing timing designated in advance.

3. The programmable logic controller according to claim 2, wherein the synchronization control unit synchronizes the variable related to the motion control in the first variable group with the corresponding variable in the second variable group at an END processing timing designated in advance as the refresh processing timing.

4. The programmable logic controller according to claim 2, wherein the synchronization control unit synchronizes the variable related to the motion control in the first variable group with the corresponding variable in the second variable group at an execution timing of inter-unit synchronization designated in advance as the refresh processing timing.

5. The programmable logic controller according to claim 2, wherein the synchronization control unit synchronizes the variable related to the motion control in the first variable group with the corresponding variable in the second variable group at an execution timing of a task designated in advance as the refresh processing timing.

6. The programmable logic controller according to claim 1, wherein when the variable related to the motion control in the first variable group is a variable input to the control logic operation, the synchronization control unit synchronizes the variable related to the motion control in the first variable group with the corresponding variable in the second variable group through the refresh processing.

7. The programmable logic controller according to claim 1, wherein when the variable related to the motion control in the first variable group is a variable output from the control logic operation, the synchronization control unit synchronizes the variable related to the motion control in the first variable group with the corresponding variable in the second variable group in response to execution of the control logic operation.

8. The programmable logic controller according to claim 1, wherein the memory includes:
a first storage area that is used by the control logic operation executed by the first core and stores the first variable group; and
a second storage area that is used by the motion control executed by the second core and stores the second variable group.

9. The programmable logic controller according to claim 1, wherein
the first variable group is updated along a scan cycle of the user program, the scan cycle being variable, and
the second variable group is updated along a control cycle of the motion control, the control cycle being constant.

10. The programmable logic controller according to claim 3, wherein when inter-unit synchronization processing is selected instead of END processing as a timing at which the variable related to the motion control in the first variable group is synchronized with the corresponding variable in the second variable group, the synchronization control unit synchronizes the variable related to the motion control in the first variable group with the corresponding variable in the second variable group at an inter-unit synchronization timing.

11. The programmable logic controller according to claim 1, wherein
when the user program includes a command word for synchronizing a predetermined variable related to the motion control in the first variable group with a predetermined corresponding variable in the second variable group, the synchronization control unit immediately synchronizes the predetermined variable related to the motion control in the first variable group with the predetermined corresponding variable in the second variable group according to the command word.

12. The programmable logic controller according to claim 1, wherein
the first variable group includes a plurality of output variables for transmitting a plurality of operation instructions issued by executing the user program,
the second variable group includes a plurality of variables corresponding to the plurality of output variables for transmitting the plurality of operation instructions,
the plurality of output variables are updated in an identical scan cycle among a plurality of consecutive scan cycles that are repeated execution cycles of the user program,
the plurality of variables corresponding to the plurality of output variables for transmitting the plurality of operation instructions in the second variable group are updated at an identical timing, and
the motion control executes the plurality of operation instructions with reference to the plurality of variables in an identical control cycle among a plurality of consecutive control cycles that are execution cycles of the motion control.
